(19) United States
(12) Patent Application Publication
(10) Pub. No.: US 2008/0062118 A1
(43) Pub. Date: Mar. 13, 2008

(54) Backlight Unit and Driving Method of the Same

(76) Inventor: Mun-soo PARK, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/854,473

(22) Filed: Sep. 12, 2007

(30) Foreign Application Priority Data
Sep. 13, 2006 (KR) 10-2006-0088543

(51) Int. Cl. G09G 3/38

(52) U.S. Cl. 345/102

(57) ABSTRACT

A backlight unit includes: a light source part that comprises a plurality of point light sources; a power supplying part that supplies power to the light source part so that the light source part outputs light having a first luminance; and a light source controller that determines a deterioration level of the light source part and controls the power supplying part so that the light source part outputs light having a second luminance lower than the first luminance if the determined deterioration level reaches a deterioration level limit, the first luminance being a luminance just before the determined deterioration level reaches the deterioration level limit.

### CROSS-REFERENCE TO RELATED APPLICATIONS

This application claims the benefit of Korean Patent Application No. 10-2006-0088543, filed on Sep. 13, 2006, in the Korean Intellectual Property Office, the disclosure of which is incorporated herein by reference in its entirety.

### BACKGROUND OF THE INVENTION

1. Field of the Invention

The present invention relates to a backlight unit and a driving method of the same.

2. Description of the Related Art

A liquid crystal display device in same embodiments comprises a liquid crystal panel and a backlight unit. The liquid crystal panel comprises a thin film transistor substrate, an opposite substrate facing the TFT substrate, and a liquid crystal layer located between both substrates. Since the liquid crystal panel can not emit light by itself, it has to be provided with light from the backlight unit located behind the thin film transistor substrate. Light emitted from the backlight unit is adjusted in its amount of transmission through the liquid crystal panel depending on alignment conditions of liquid crystal molecules in the liquid crystal layer.

Point light sources such as light emitting diodes, not a line light source such as a lamp, are being utilized as light sources in a backlight unit. A light group of emitting diodes, which typically includes a red light emitting diode, a green light emitting diode and a blue light emitting diode are utilized. Light emitted from these red, green and blue light emitting diodes is mixed together to generate white light.

However, the performance of light emitting diodes typically deteriorates with usage, which results in poor durability of the backlight unit.

### SUMMARY OF THE INVENTION

Accordingly, it is an aspect of the present invention to provide a backlight unit with improved durability of a light source part.

It is another aspect of the present invention to provide a driving method of a backlight unit with improved durability of a light source part.

The foregoing and/or other aspects of the present invention can be achieved by providing a backlight unit comprising: a light source part that comprises a plurality of point light sources; a power supplying part that supplies power to the light source part so that the light source part outputs light having a first luminance; and a light source controller that determines a deterioration level of the light source part and controls the power supplying part so that the light source part outputs light having a second luminance lower than the first luminance if the determined deterioration level reaches a deterioration level limit, the first luminance being a luminance just before the determined deterioration level reaches the deterioration level limit.

According to the embodiment of the present invention, the plurality of point light sources comprises a plurality of light emitting diodes that emits light having different colors.

According to the embodiment of the present invention, the backlight unit further comprises an optical sensor that measures a characteristic of the light outputted from the light source part.

According to the embodiment of the present invention, the power supplying part supplies the power to each of the light emitting diodes, and the light source controller controls the power supplying part so that the light source part supplies white light.

According to the embodiment of the present invention, the light source controller determines the deterioration level based on driving time of the light source part.

According to the embodiment of the present invention, the characteristic of the light measured by the optical sensor comprises luminance, and wherein the light source controller determines the deterioration level based on luminance of the light source part and a level of power supplied to the light source part.

According to the embodiment of the present invention, the optical sensor measures a characteristic of light emitted from each of the light emitting diodes, and wherein the light source controller determines the deterioration level for each of the light emitting diodes.

According to the embodiment of the present invention, the deterioration level is set for one of the plurality of light emitting diodes.

According to the embodiment of the present invention, the power supplying part supplies the power to the light source part in a pulse width modulation (PWM) manner.

According to the embodiment of the present invention, the light source controller determines the deterioration level based on a duty cycle of the power.

The foregoing and/or other aspects of the present invention can be achieved by providing a driving method of a backlight unit comprising a light source part which comprises a plurality of light emitting diodes that emits light having different colors, comprising: supplying power to the light source part so that the light source part supplies white light having a first luminance; determining a deterioration level of the light source part; and supplying white light having a second luminance lower than the first luminance if the deterioration level of the light source part reaches a deterioration level limit.

According to the embodiment of the present invention, the deterioration level is determined based on driving time of the light source part.

According to the embodiment of the present invention, the deterioration level is determined based on luminance of the light source part and a level of power supplied to the light source part.

According to the embodiment of the present invention, the power is supplied in a pulse width modulation (PWM) manner.

According to the embodiment of the present invention, the deterioration level is determined based on a duty cycle of the power.

The foregoing and/or other aspects of the present invention can be achieved by providing a driving method of a backlight unit comprising a light source part that supplies light and comprises a plurality of light emitting diodes that emits light having different colors, comprising: supplying power to each of the light emitting diodes so that the light source part supplies white light having a first luminance; determining a deterioration level of each of the light emitting diodes; supplying the white light having the first luminance while adjusting a level of the power supplied to each of the light emitting diodes depending on the deterioration level of each of the light emitting diodes; and supplying white light having a second luminance lower than the first luminance if the deterioration level of one of the light emitting diodes reaches a deterioration level limit.

### BRIEF DESCRIPTION OF THE DRAWINGS

The above and/or other aspects of the present invention will become apparent and more readily appreciated from the following description of the embodiments, taken in conjunction with the accompanying drawings of which:

FIG. 1 is a block diagram of a liquid crystal display device according to an exemplary embodiment of the present invention;

FIGS. 2 and 3 are, respectively, plots of lifetime versus temperature and luminance versus time, for light emitting diodes, both showing the deterioration of performance of a light emitting diode;

FIGS. 4A and 4B are plots of output voltage versus luminance for red, green and blue light emitting diodes.

FIG. 5 is a flow chart illustrating a driving method of a liquid crystal display device according to a first exemplary embodiment of the present invention;

FIG. 6 is a view illustrating graphically a driving method of the liquid crystal display device according to the first exemplary embodiment of the present invention;

FIG. 7 is a plot of luminance versus time which illustrates luminance change over time in the driving method of the liquid crystal display device according to the first exemplary embodiment of the present invention;

FIG. 8 is a flow chart illustrating a driving method of a liquid crystal display device according to a second exemplary embodiment of the present invention;

FIG. 9 illustrates the driving method of the liquid crystal display device according to the second exemplary embodiment of the present invention;

FIG. 10 is a flow chart illustrating a driving method of a liquid crystal display device according to a third exemplary embodiment of the present invention;

FIG. 11 is a view illustrating a driving method of a liquid crystal display device according to a fourth exemplary embodiment of the present invention; and

FIGS. 12 and 13 are plots showing luminance versus time in driving methods of a liquid crystal display device according to fifth and sixth embodiments of the present invention, respectively.

### DETAILED DESCRIPTION OF THE EXEMPLARY EMBODIMENT

Reference will now be made in detail to exemplary embodiments of the present invention, examples of which are illustrated in the accompanying drawings.

In the following embodiments, although a point light source is illustrated with a light emitting diode, the point light source of the present invention is not limited the light emitting diodes but may be applied to other light emitting elements without any limitation.

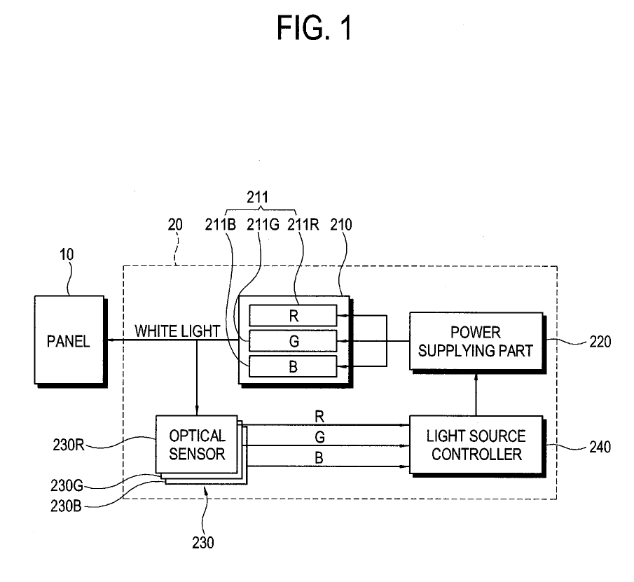

A liquid crystal display device according to an exemplary embodiment of the present invention is described below with reference to FIG. 1.

A liquid crystal display device 1 comprises a liquid crystal panel 10 and a backlight unit 20. The liquid crystal panel 10 adjusts the amount of transmission of light received from the backlight unit 20 that is passed outwardly toward a viewer.

The backlight unit 20 comprises a light source part 210 that emits light, a power supplying part 220 that supplies power to the light source part 210, an optical sensor 230 that detects a characteristic of light emitted from the light source part 210, and a light source controller 240 that controls the power supplying part 220 based on a result of the detection of the optical sensor 230.

The light source part 210 is provided with light emitting diodes 211. The light emitting diodes 211 comprise a red light emitting diode 211R, a green light emitting diode 211G, and a blue light emitting diode 211B. Light of three colors emitted from the light emitting diodes 211 is mixed together, and then is supplied to the liquid crystal panel 10. Although not shown, the light source part 210 further comprises a circuit board on which the light emitting diodes 211 are mounted.

The light emitting diodes 211 deteriorates with driving time. That is, when the same current is supplied to the light emitting diodes 211 at a normal temperature, luminance decreases as a function of the amount of time the diodes have been used. Typically, the time when luminance reaches 50% of initial luminance at the same level of current is regarded as lifetime (or durability) of the light emitting diodes 211.

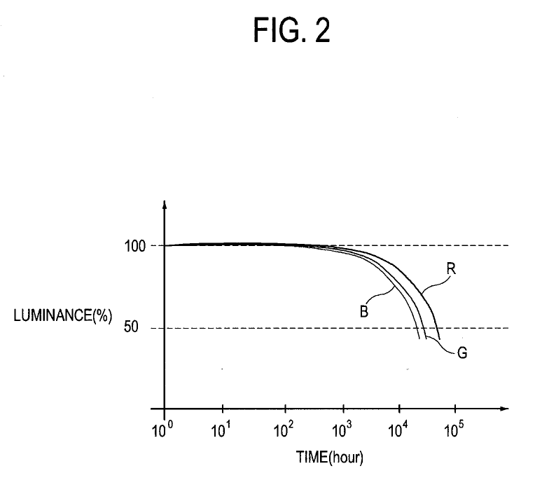

As can be seen from FIG. 2, the light emitting diodes 211 typically have lifetime of tens of thousands of hours. The blue light emitting diode 211B has the shortest lifetime.

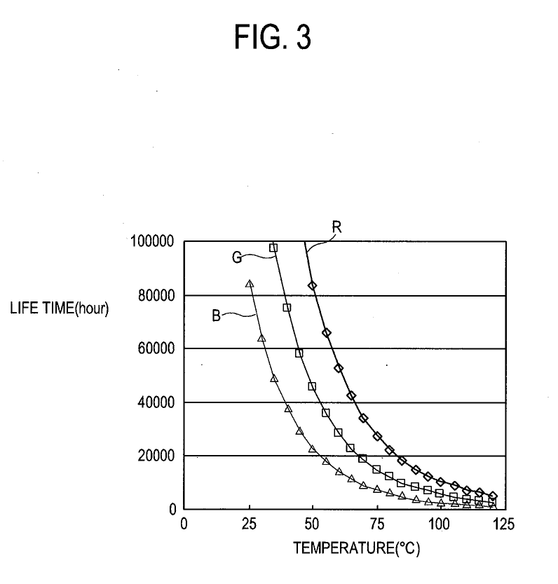

The lifetime of the light emitting diodes 211 is also affected by temperature. FIG. 3 shows that the lifetime decreases suddenly as temperature increases. In this case, the blue light emitting diode 211B has the shortest lifetime. In the following exemplary embodiments, although the lifetime of the blue light emitting diode 211B is exemplified to be shortest, the present invention is not limited to this.

The power supplying part 220 may supply power to the light source part 210 using a pulse width modulated (PWM) signal, or by applying a DC voltage. When a PWM signal is applied, the duty cycle is adjusted, with a constant level of current. In the direct current manner, a level of the current varies.

The power supplying part 220 may supply power of different levels to the respective light emitting diodes 211. For example, a level of power supplied to the blue light emitting diode 211B may be higher than that supplied to the red light emitting diode 211R. Here, the level of power refers to (i) a level of current and/or a duty cycle in the PWM technique and (ii) refers to a level of current in the direct current manner. In the pulse with modulation technique using a constant level of current, a higher level of power means a higher duty cycle.

The optical sensor unit 230, which includes sensors 230R, 230G and 230B which are associated with the red, green and blue LEDs respectively, measures an optical characteristic of each of the light emitting diodes 211R, 211G and 211B, that is, luminance of red, green and blue color light via sensor units 230R, 230G and 230B. The optical sensor 230 may measure color coordinates of red, green and blue color light.

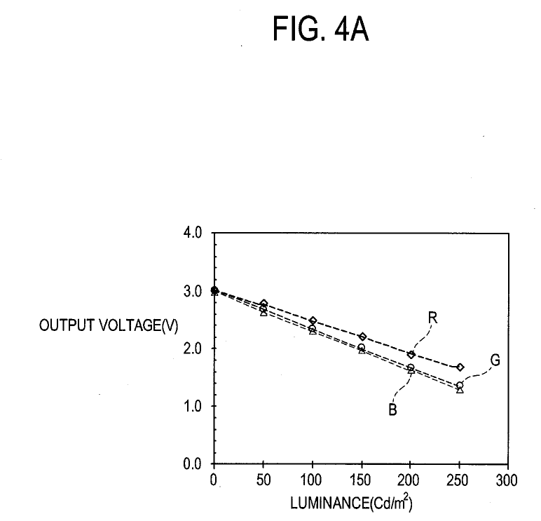

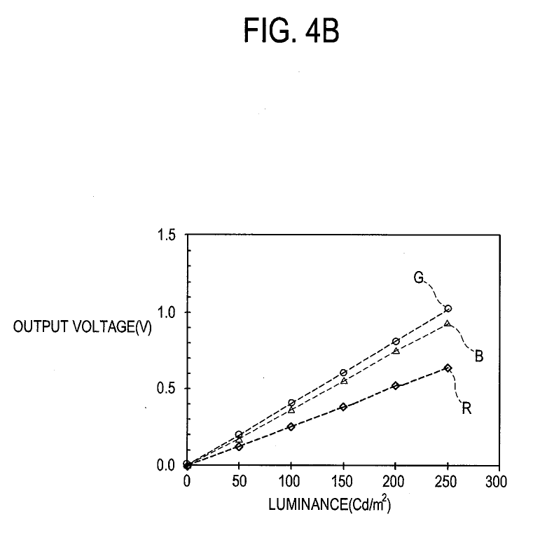

FIGS. 4A and 4B are plots illustrating the optical characteristics of the light emitting diodes 211, which are measured by different optical sensors 230. FIGS. 4A and 4B show that the R, G, and B optical sensors 230R, 230G and 230B, respectively, output different voltages for each luminance, and different colors have different luminances. The optical sensor 230 that measured the optical characteristic shown in FIG. 4A outputs a lower voltage with increase of luminance, while the optical sensor 230 that measured the optical characteristic shown in FIG. 4B outputs a higher voltage with increase of luminance.

The light source controller 240 controls the power supplying part 220 based on the optical characteristics, i.e., luminance for each color, measured by the optical sensor 230. Based on a result of the measurement of the optical sensor 230, the light source controller 240 provides signals to the power supplying part 220 such that the RG and B LEDs, 211R, 211G and 211B, in the light source part 210 are appropriately driven to emit white light having desired luminance. For example, if the red color light is insufficient to obtain white light, a level of power supplied to the red light emitting diode 211R is increased, or if the white light has low luminance, a level of power supplied to each of the light emitting diodes 211 is increased.

As described above, the performance of light emitting diodes 211 deteriorates over time, which results in reduced luminance for a given drive level of power. Accordingly, the level of power has to be increased to obtain white light having the same luminance. In the PWM driving technique, typically, the duty cycle is increased, however the level of current unchanged. This is because a characteristic of light varies if the level of current varies. In the direct current manner, the level of current is increased to increase the luminance.

However, as deterioration of the light emitting diodes 211 progresses, the duty cycle cannot be further increased in the PWM manner, and the level of current can not be further increased because of a change in the characteristic of light in the direct current manner. In addition, as the level of power is increased, temperature of the light emitting diodes 211 is increased, thereby accelerating deterioration of the light emitting diodes 211, which results in shortening of the lifetime of the light source part 210.

In this exemplary embodiment, when deterioration level of the light source part 210 reaches a deterioration level limit, the light source controller 240 decreases a level of current, thereby increasing the lifetime of the light source part 210. In this case, luminance is decreased as the level of current is decreased. Hereinafter, exemplary embodiments related to this will be described in detail in conjunction with the accompanying drawings.

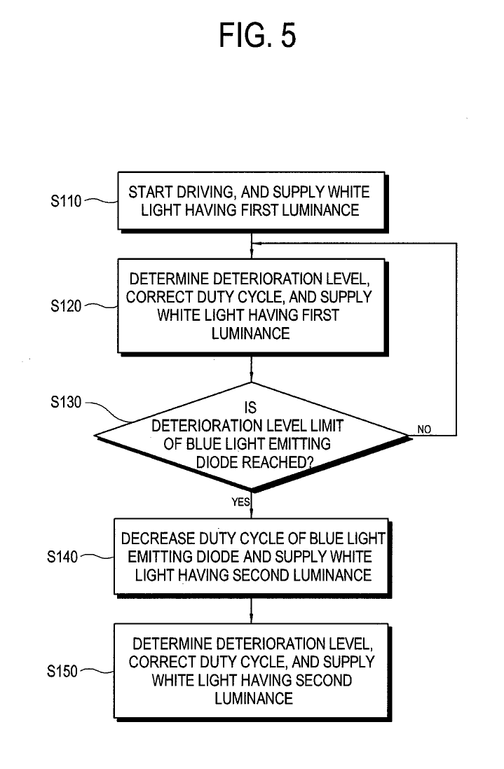

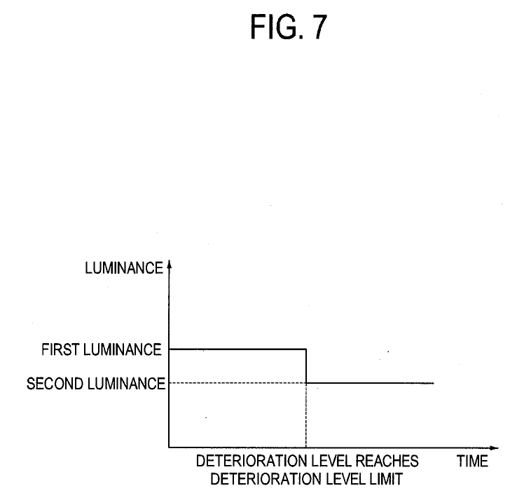

A driving method of a liquid crystal display device according to a first exemplary embodiment of the present invention is described below with reference to FIGS. 5 to 7. In the first embodiment, the power supplying part 220 supplies power to the light source part 210 in the pulse width modulation manner, and a deterioration level limit is set for the blue light emitting diode 211B.

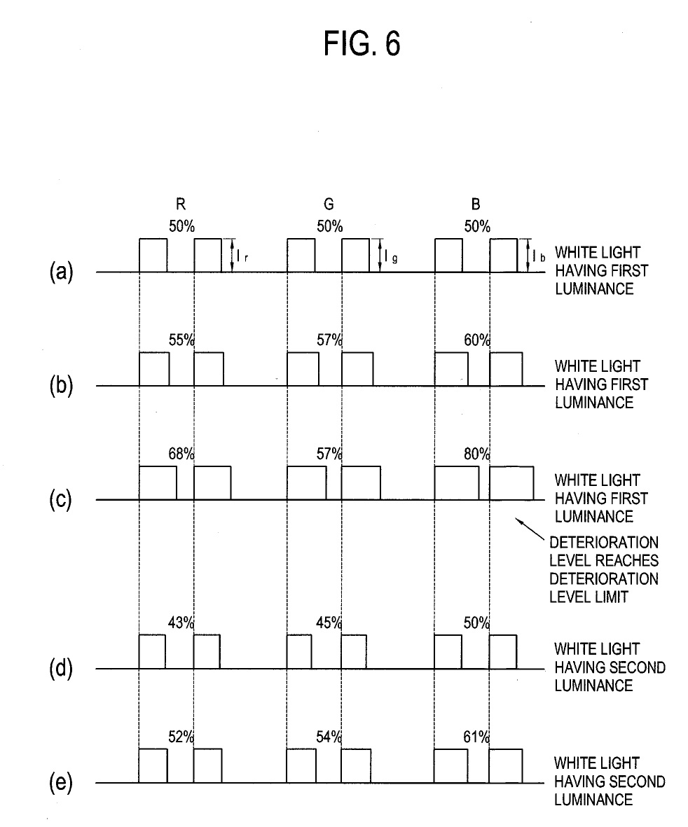

First, power is supplied to the light emitting part 210 and, white light having a first luminance is supplied to the liquid crystal panel 10 at operation S110. In the operation S110, it can be seen from (a) of FIG. 6 that the light emitting diodes 211 have the same duty cycle of 50%. In this case, levels of current Ir, Ig and Ib may be different from each other. In another exemplary embodiment, the light emitting diodes 211 may have different duty cycles at an initial operation.

Next, at operation S120, a deterioration level of the light emitting part 210 is determined, the duty cycles are corrected depending on the determined deterioration level, and the white light having the first luminance continues to be supplied. It can be seen from (b) of FIG. 6 that the duty cycles are increased for all the light emitting diodes 211. In this exemplary embodiment, the blue light emitting diode 211B has the highest deterioration level and accordingly the highest rate of increase of duty cycle.

In this course, the light source controller 240 determines the deterioration level of each of the light emitting diodes 211. The light source controller may determine the deterioration level of each of the light emitting diodes 211 based on the increased duty cycles.

While supplying of the white light having the first luminance, the light source controller 240 determines whether or not the deterioration level of the blue light emitting diode 211B reaches a deterioration level limit at operation S130. Since the blue light emitting diode 211B typically deteriorates faster than the red and green light emitting diodes 211R and 211G, the output of the blue light emitting diode 211B is used in determining the deterioration level of the light source part 210 in the first exemplary embodiment.

In the first exemplary embodiment, the deterioration level limit is set as a duty cycle of 80%. It can be seen from (c) of FIG. 6 that power supplied to the blue light emitting diode 211b reaches the duty cycle of 80%. At this time, duty cycles of the red and green light emitting diodes 211R and 211G have a duty cycle of less than 80%.

As an alternative embodiment, the deterioration level limit may be set as a ratio of current duty cycle to initial duty cycle (for example, 1.3) or an increase speed of duty cycle (for example, increase of duty cycle by more than 0.1% per 100 hours).

When the deterioration level of the blue light emitting diode 211B reaches the deterioration level limit, that is, when the power supplied to the blue light emitting diode 211B reaches the duty cycle of 80%, the duty cycle of the power supplied to the blue light emitting diode 211B is decreased at operation S140.

It can be seen from (d) of FIG. 6 that the duty cycle of the power supplied to the blue light emitting diode 211B is decreased to the duty cycle of 50%, which is an initial duty cycle. As an alternative embodiment, the power may be set to have a duty cycle different from the initial duty cycle, for example, a duty cycle of 70% when the deterioration level of the blue light emitting diode 211b reaches the deterioration level limit.

Simultaneously, duty cycles of the red and green light emitting diodes 211R and 211G are also adjusted to output the white light. Since the red and green light emitting diodes 211R and 211G have a deterioration level lower than that of the blue light emitting diode 211B, the duty cycles of the red and green light emitting diodes 211R and 211G are smaller than that of the blue light emitting diode 211B.

A second luminance of the white light having the decreased duty cycle is lower than the first luminance. This is because the blue light emitting diode 211B has been already significantly deteriorated thus, although the power is supplied to the blue light emitting diode 211B has the duty cycle of 50% equal to the initial duty cycle, the first luminance of the white light cannot be maintained.

Next, at operation S150, a deterioration level of the light emitting part 210 is determined, the duty cycles are corrected depending on the determined deterioration level, and the white light having the second luminance continues to be supplied. It can be seen from (e) of FIG. 6 that the duty cycles are increased for all the light emitting diodes 211 as the light source part 21 deteriorates. Since details of this process have been described above, explanation thereof will be omitted for the sake of simplification of description.

According to the above-described first exemplary embodiment, the white light having the first luminance is supplied until the power supplied to the blue light emitting diode 211B reaches the duty cycle of 80%, that is, until the deterioration level of the blue light emitting diode 211B reaches the deterioration level limit. After the power supplied to the blue light emitting diode 211B reaches the duty cycle of 80%, that is, after the deterioration level of the blue light emitting diode 211B reaches the deterioration level limit, the duty cycle is decreased, and accordingly, the white light having the second luminance lower than the first luminance is supplied.

According to the first exemplary embodiment, the light emitting diodes 211, particularly, the blue light emitting diode 211B, are prevented from being excessively deteriorated, thereby increasing the lifetime (or durability) of the light source part 210.

Although the blue light emitting diode 211B is taken for determining deterioration level of the light source part 210 in the first exemplary embodiment, one of the red and green light emitting diodes 211R and 211G may be taken for determining deterioration level in an alternative embodiment.

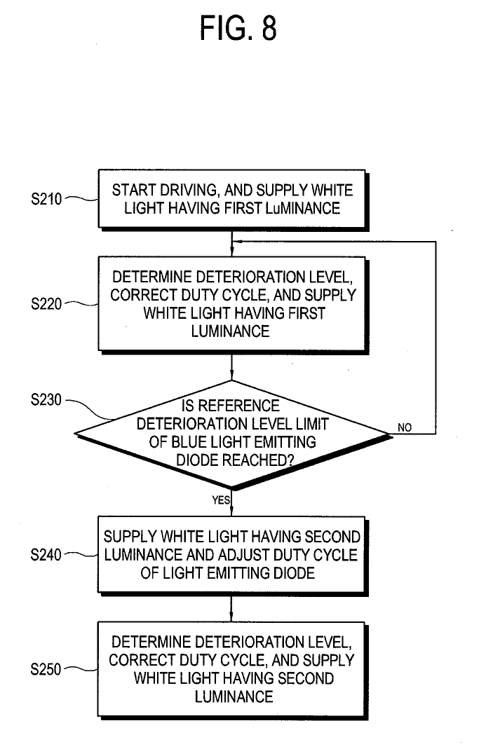

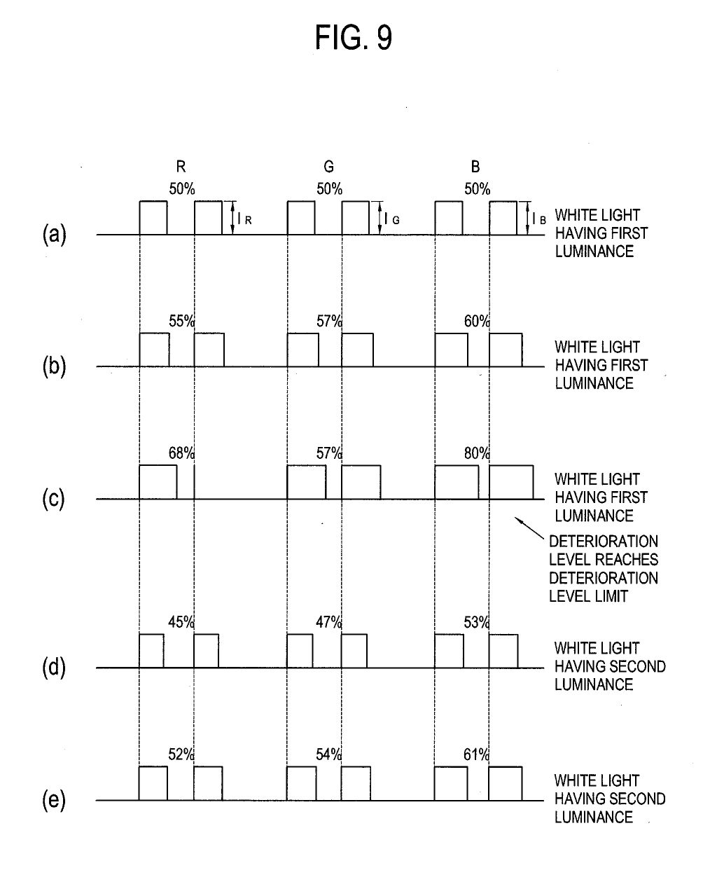

A driving method of a liquid crystal display device according to a second exemplary embodiment of the present invention is described below with reference to FIGS. 8 and 9. In the second exemplary embodiment, only parts which are different from the first embodiment will be described.

When the deterioration level of the blue light emitting diode 211B reaches the deterioration level limit, that is, when the power supplied to the blue light emitting diode 211B reaches the duty cycle of 80%, the duty cycle of power supplied to each of the light emitting diodes 211R, 211G and 211B is adjusted to supply the white light having the second luminance and for example, the second luminance may be set 80% of the first luminance.

It can be seen from (d) of FIG. 9 that the duty cycle of the power supplied to each of the light emitting diodes 211 to supply the white light having the second luminance is decreased. At this time, the duty cycle of the power supplied to the blue light emitting diode 211B having a higher deterioration level is greater than those of the power supplied to the red and green light emitting diodes 211R and 211G.

According to the second exemplary embodiment, the light emitting diodes 211 are prevented from being excessively deteriorated, thereby increasing the lifetime (or durability) of the light source part 210.

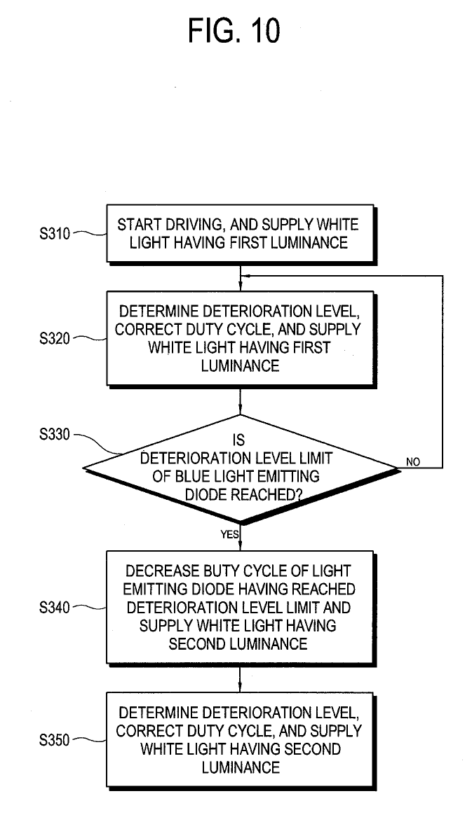

A driving method of a liquid crystal display device according to a third exemplary embodiment of the present invention is described below with reference to FIG. 10. In the third exemplary embodiment, only parts different from the first embodiment will be described.

The deterioration level limit is set for all the light emitting diodes 211. For example, duty cycles of 75%, 78% and 80% are set as the deterioration level limits for the red, green and blue light emitting diodes 211R, 211G and 211B, respectively.

When anyone of the light emitting diodes 211 reaches the deterioration level limits, the duty cycles of the light emitting diodes 211 are decreased. For example, with the set deterioration level limits, when the green light emitting diode 211G has a duty cycle of 77% and the blue light emitting diode 211B has a duty cycle of 78%, if the red light emitting diode 211R reaches the duty cycle of 75%, the duty cycles of all the light emitting diodes 211 are decreased.

According to the third exemplary embodiment, it is possible to cope with unexpected sudden deterioration of any of the light emitting diodes 211.

As an alternative embodiment, when all the light emitting diodes 211 reach deterioration level limits, the duty cycles may be adjusted. As another alternative embodiment, the light emitting diodes 211 may have the same deterioration level limits, for example, a duty cycle of 80%.

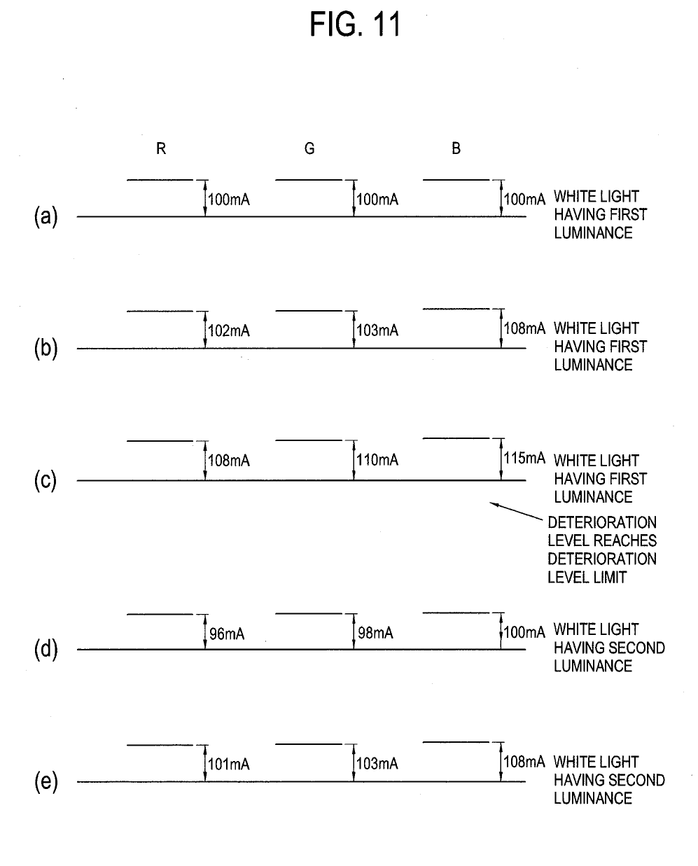

A driving method of a liquid crystal display device 1 according to a fourth exemplary embodiment of the present invention is described below with reference to FIG. 11. In the fourth exemplary embodiment, only parts different from the first embodiment will be described. In the fourth exemplary embodiment, the deterioration level limit is set for the blue light emitting diode 211B like the first exemplary embodiment.

Power is supplied to the light source part 210 in the direct current manner. It can be seen from (a) of FIG. 11 that the light emitting diodes 211 are supplied with the same level of current of 100 mA at an initial operation. As an alternative embodiment, levels of current supplied to the light emitting diodes 211 may be different at an initial operation.

Thereafter, as shown in (b) of FIG. 11, as deterioration of the light emitting diodes 211 progresses, the levels of current supplied to each of the light emitting diodes 211 are increased. Particularly, the level of current supplied to the blue light emitting diode 211B having a higher rate of deterioration is greatly increased.

Thereafter, as shown in (c) of FIG. 11, as deterioration of the light emitting diodes 211 progresses further, the level of current supplied to the blue light emitting diode 211B reaches a set deterioration level limit, 115 mA.

When the deterioration level of the blue light emitting diode 211B reaches the deterioration level limit, the level of current supplied to the blue light emitting diode 211B is decreased to 100 mA which is the initial level of current, as shown in (d) of FIG. 11. Simultaneously, levels of current supplied to the red and green light emitting diodes 211R and 211G are also decreased to output the white light. Since the red and green light emitting diodes 211R and 211G have deterioration rates slower than that of the blue light emitting diode 211B, the levels of current of the red and green light emitting diodes 211R and 211G are smaller than that of the blue light emitting diode 211B.

A second luminance of the white light having the decreased level of current is lower than the first luminance. This is because the blue light emitting diode 211B has been already significantly deteriorated and even if the power is supplied to the blue light emitting diode 211B has the level of current equal to the initial level of current, the first luminance of the white light cannot be maintained.

Next, a deterioration level of the light emitting part 210 is determined, the levels of current are corrected depending on the determined deterioration level, and the white light having the second luminance continues to be supplied. It can be seen from (e) of FIG. 11 that the level of current are again increased for all the light emitting diodes 211 as the light source part 210 deteriorates.

According to the fourth exemplary embodiment, the light emitting diodes 211, particularly, the blue light emitting diode 211B, are prevented from undergoing excessive deterioration, thereby increasing the lifetime (or durability) of the light source part 210. When the levels of current are changed, a characteristic of light emitted from the light emitting diodes 211 varies accordingly, thereby making it difficult to output the white light. Accordingly, the levels of current are prevented from being suddenly varied, and thus, it is easy for the light source part 210 to output the white light.

The deterioration levels of the light emitting diodes 211 are determined based on the levels of current supplied to the light emitting diodes 211, that is, the levels of current increased to supply the same luminance in the fourth exemplary embodiment. The deterioration levels of the light emitting diodes 211 may be determined in a different way according to a fifth exemplary embodiment of the present invention, which will be described below.

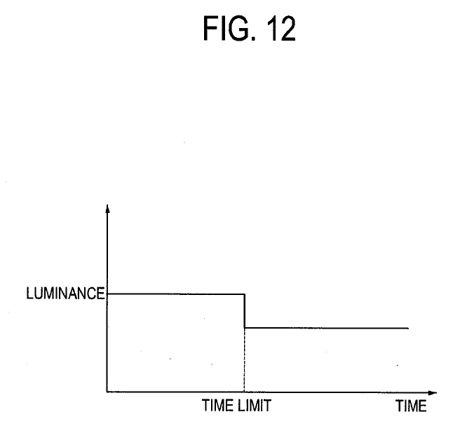

FIG. 12 is a plot showing luminance change with time in a driving method of a liquid crystal display device 1 according to a fifth exemplary embodiment of the present invention. In the fifth exemplary embodiment, the deterioration level limit is determined based on driving time of the light source part 210. Specifically, since the deterioration levels of the light emitting diodes 211 are proportional to the driving time of the light source part 210, the deterioration level limit is set by the driving time. The light source controller 240 further comprises a timer to count the driving time.

Driving time limit as the deterioration level limit may be set as 50% of proposed lifetime of the light source part 210, for example. Accordingly, if the proposed lifetime is 40,000 hours, levels of voltage supplied to the light emitting diodes 211 are decreased when the driving time reaches 20,000 hours. Accordingly, the luminance is decreased. The driving time limit may be defined through experiment or simulation, and may be set as time immediately before the light emitting diodes 211 shows a sudden deterioration.

As an alternative embodiment, the deterioration level of the light emitting diodes 211 may be determined by detecting the amount of one of current and voltage output from the light emitting diodes 211. For example, since the amount of current output from the light emitting diodes 211 decreases as the light emitting diodes 211 deteriorate, the deterioration level of the light emitting diodes 211 may be determined based on the magnitude of output current. In addition, the luminance of the light emitting diodes 211 is a function of the magnitude of the output current. The optical sensor. 230 may be omitted when the deterioration level is determined by any of the above methods where light output is not measured to determine a deterioration level.

Although the levels of power supplied to the light emitting diodes 211 are once decreased in the above embodiments, the present invention is not limited to this. The levels of power supplied to the light emitting diodes 211 may be decreased in a different way according to a sixth exemplary embodiment of the present invention, which sixth embodiment is described below.

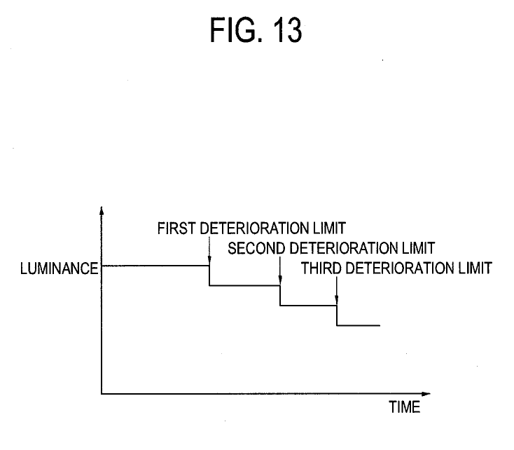

FIG. 13 is a plot showing luminance with time in a driving method of a liquid crystal display device according to a sixth exemplary embodiment of the present invention. FIG. 13 shows a plurality of deterioration level limits. For example, duty cycles of 75%, 70% and 65% for the blue light emitting diode 211B may be set as first, second and third deterioration level limits, respectively.

In an operation of supplying the white light having a first luminance, when the light emitting diodes 211 reach the first deterioration level limit, the duty cycle is decreased to supply the white light having a second luminance. In an operation of supplying the white light having the second luminance, the deterioration of the light emitting diodes 211 is progressed, and the duty cycle is increased. When the light emitting diodes 211 reach the second deterioration level limit, the duty cycle is again decreased to supply the white light having a third luminance. When the light emitting diodes 211 reaches the third level limit, the duty cycle is again decreased to supply the white light having a fourth luminance. In this case, the time for which the white light having the same luminance is supplied may be shortened with driving time of the light source part 210.

According to the sixth exemplary embodiment, it is possible to increase the lifetime of the light source part 210 while preventing a sudden change of the luminance.

As apparent from the above description, the present invention provides a backlight unit with increased lifetime (or durability) of the light source.

In addition, the present invention provides a driving method of a backlight unit with increased lifetime (or durability) of the light source.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A backlight unit for a liquid crystal display device, the backlight unit comprising:
a light source part comprising a plurality of light sources;
a power supplying part that supplies power to the light source part so that the light source part emits light;
a light source controller that determines a deterioration level of the light source part and controls the power supplying part so that the light source part emits light having a second luminance lower than the first luminance if the determined deterioration level reaches a deterioration level limit, the first luminance being a luminance just before the determined deterioration level reaches the deterioration level limit.

2. The backlight unit according to claim 1, wherein the plurality of light sources comprises a plurality of light emitting diodes that emit light having different colors.

3. The backlight unit according to claim 2, wherein the backlight unit further comprises an optical sensor coupled to the light source controller, the optical sensor being operative to measure a characteristic of the light emitted by the light source part.

4. The backlight unit according to claim 3, wherein the power supplying part is operative to separately supply power to each of the light emitting diodes, and
further wherein the light source controller controls the power supplying part such that the light source part emits white light.

5. The backlight unit according to claim 1, wherein the light source controller determines the deterioration level based on a driving time of the light source part.

6. The backlight unit according to claim 3, wherein the characteristic of the light measured by the optical sensor comprises luminance, and
wherein the light source controller determines the deterioration level of the light emitting diodes based on a luminance of light emitted by the light emitting diodes and a level of power supplied to the light emitting diodes.

7. The backlight unit according to claim 4, wherein the optical sensor measures a characteristic of light emitted from each of the light emitting diodes, and
wherein the light source controller determines the deterioration level for each of the light emitting diodes.

8. The backlight unit according to claim 7, wherein the deterioration level limit is set for one of the plurality of light emitting diodes.

9. The backlight unit according to claim 6, wherein the power supplying part supplies the power to the light source part in a pulse width modulation (PWM) manner.

10. The backlight unit according to claim 9, wherein the light source controller determines the deterioration level based on a duty cycle of the power.

11. The backlight unit according to claim 6, wherein the power supplying part supplies the power to the light source part in a direct current manner.

12. A driving method of a backlight unit which comprises a plurality of light emitting diodes that emits light having different colors, comprising:
supplying power to the light source part so that the light source part supplies white light having a first luminance to the liquid crystal display panel;
determining a deterioration level of the light source part; and
supplying white light having a second luminance lower than the first luminance to the liquid crystal display panel if the deterioration level of the light source part reaches a deterioration level limit.

13. The driving method according to claim 12, wherein the deterioration level is determined based on driving time of the light source part.

14. The driving method according to claim 12, wherein the deterioration level is determined based on luminance of the light source part and a level of power supplied to the light source part.

15. The driving method according to claim 14, wherein the power is supplied in a pulse width modulation (PWM) manner.

16. The driving method according to claim 15, wherein the deterioration level is determined based on a duty cycle of the power.

17. A driving method of a backlight unit which comprises a plurality of light emitting diodes, each of which emits light of a different color, comprising:
supplying power to each of the light emitting diodes so that the light source part supplies white light having a first luminance;
determining a deterioration level of each of the light emitting diodes;
supplying the white light having the first luminance while adjusting a level of the power supplied to each of the light emitting diodes depending on the deterioration level of each of the light emitting diodes; and
supplying white light having a second luminance lower than the first luminance if the deterioration level of one of the light emitting diodes reaches a deterioration level limit.
